(19) United States
(12) Patent Application Publication
(10) Pub. No.: US 2008/0073996 A1
(43) Pub. Date: Mar. 27, 2008

(54) MOTOR STATOR

(75) Inventors: CHENG-FANG HSIAO, Tu-Cheng (TW); CHING-HSING HUANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Taipei Hsien (TW)

(21) Appl. No.: 11/309,784

(22) Filed: Sep. 26, 2006

(51) Int. Cl. H02K 37/14; H02K 1/12

(52) U.S. Cl. 310/257; 310/49 R

(57) ABSTRACT

A stator motor includes at least one claw-pole assembly (30a, 30b) for coils wound thereon. The at least one claw-pole assembly includes a pair of yokes (10a, 20a, 10b, 20b) facing towards each other. Each of the yokes is ring-shaped with a plurality of pole teeth (50) extending therefrom. The pole teeth of each yoke are spaced from each other and define a plurality of slots (80) therebetween. The pole teeth of the two yokes are intermeshed with each other and are arranged in alternating fashion along a circumferential direction of the yokes. The teeth of the two yokes cooperatively form a cylinder-shaped sidewall for receiving a rotor therein and the coils wound thereon. Several pins (70, 23) extend from and are integrally formed with at least one of the yokes for electrically connecting the coils to a power source.

### 1. FIELD OF THE INVENTION

The present invention relates generally to motors, and more particularly to a stator for use in a claw pole permanent magnet step motor, such as a camera motor.

### 2. DESCRIPTION OF RELATED ART

Recently, remarkable progress has been made in miniaturization of various devices. Accordingly, various devices have adopted a plurality of specific motors as required for their functions. Step motors are best suited in particular for positioning control.

Usually a step motor includes a stator with windings wound therearound, and a rotor disposed rotatably inside the stator. The stator includes a pair of stator yokes facing towards each other. Each of the yokes includes a plurality of pole teeth extending perpendicularly therefrom. The pole teeth of the two yokes are intermeshed with each other with a gap therebetween, and cooperatively form a cylinder to wind the windings thereon. Resin is contained in the gaps of the teeth of the two yokes to fix the two yokes together. A pin holder is integrally formed with the stator by insert-molding when the resin is injected into the gaps. Several holes are defined in the pin holder, and several pins are received in the corresponding holes. Each pin has one end to be connected to an end of the windings, and another end for connecting the windings to a power source electrically. Thus a current can be applied to the windings to generate an alternating magnet field to drive the rotor into rotation during operation of the motor.

In this motor, the pins are inserted into the holes and thus to connect the windings to the power source. As the size of the motor is limited, it is not easily to insert the pins into the holes of the pin holder accurately. The pins thus cannot be connected to the windings properly. Worse of all, the pins may become separated from the holes. The motor cannot be linked to the power source correctly, and thus cannot operate. On the other hand, the motor needs to form the pin holder and then inserts the pins into the pin holder, which causes the producing and assembly of the motor to be inconvenient and costly.

### SUMMARY OF THE INVENTION

According to a preferred embodiment of the present invention, a motor stator includes at least one claw-pole assembly for coils wound thereon. The at least one claw-pole assembly includes a pair of yokes facing towards each other. Each of the yokes is ring-shaped with a plurality of pole teeth extending therefrom. The pole teeth of each yoke are spaced from each other and define a plurality of slots therebetween. The pole teeth of the two yokes are intermeshed with each other and are alternatively arranged along a circumferential direction of the yokes. The teeth of the two yokes cooperatively form a cylinder-shaped sidewall for receiving a rotor therein and coils wound thereon. Several pins extend from and are integrally formed with at least one of the yokes for connecting the coils to a power source electrically.

Other advantages and novel features of the present invention will be drawn from the following detailed description of a preferred embodiment of the present invention with attached drawings, in which:

### BRIEF DESCRIPTION OF THE DRAWINGS

Many aspects of the present motor stator can be better understood with reference to the following drawings. The components in the drawings are not necessarily drawn to scale, the emphasis instead being placed upon clearly illustrating the principles of the present motor stator. Moreover, in the drawings, like reference numerals designate corresponding parts throughout the several views:

FIG. 1 is an isometric, exploded view of a motor stator in accordance with a preferred embodiment of the present invention;

FIG. 2 is an isometric, assembled view of the motor stator of FIG. 1;

FIG. 3 shows a top view of the motor stator; and

FIG. 4 shows an alternative embodiment of the motor stator of the present invention.

### DETAILED DESCRIPTION OF THE INVENTION

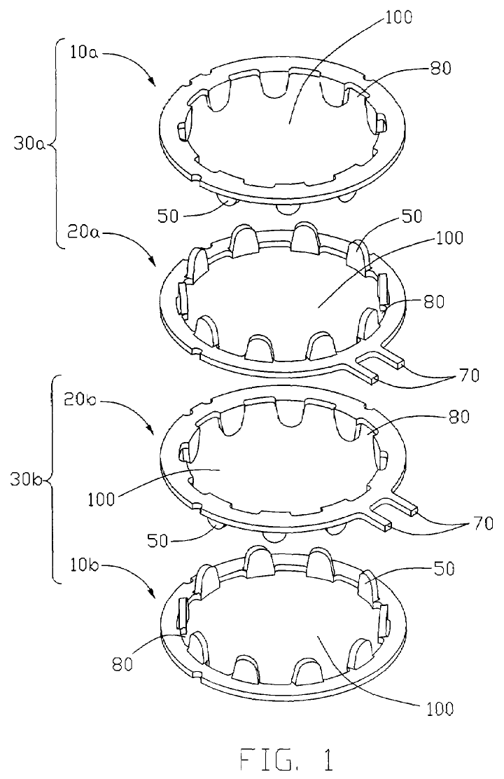

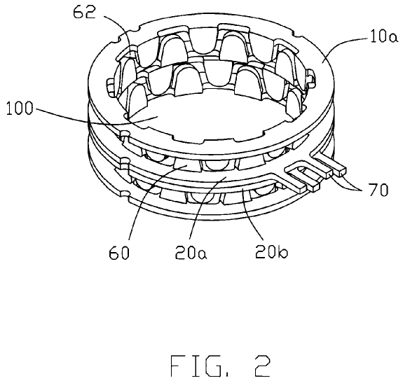

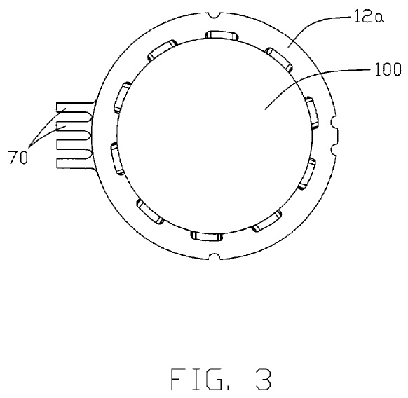

Referring to FIGS. 1-3, a motor stator according to a preferred embodiment can be used in a claw pole permanent-magnet stepping motor which includes a rotor (not shown) disposed rotatably inside the stator. The stator includes two claw-pole assemblies (i.e., an upper claw-pole assembly 30a and a lower claw-pole assembly 30b) arranged back-to-back. Each of the claw-pole assemblies 30a, 30b includes an outer yoke 10a, 10b and an inner yoke 20a, 20b facing towards each other.

Each of the yokes 10a, 10b, 20a, 20b of the claw-pole assemblies 30a, 30b is ring-shaped with a circular hole 100 defined therein. A plurality of pole teeth 50 extends perpendicularly from an inner circumference of each yoke 10a, 10b, 20a, 20b. The pole teeth 50 of each yoke 10a, 10b, 20a, 20b are evenly spaced from each other along a circumferential direction thereof and thus define a plurality of slots 80 therebetween. Each of the pole teeth 50 has a shape and size the same as those of the other teeth 50. Each tooth 50 forms an arc-shaped free end. Each of the slots 80 has a size a little larger than that of the tooth 50 so as to receive a corresponding tooth 50 therein. Two pins 70 extend outwardly from an outer circumference of each inner yoke 20a, 20b. The pins 70 are integrally formed with the inner yokes 20a, 20b. The two pins 70 of each inner yoke 20a, 20b are spaced from and parallel to each other.

During assembly, each of the outer yokes 10a, 10b combines with a corresponding inner yoke 20a, 20b to form a claw-pole assembly. The inner yokes 20a, 20b and the outer yokes 10a, 10b of each claw-pole assembly 30a, 30b face to each other. The teeth 50 of each outer yoke 10a, 10b insert into the slots 80 of the corresponding inner yoke 20a, 20b. The teeth 50 of each inner yoke 20a, 20b insert into the slots 80 of the corresponding outer yoke 10a, 10b. Thus the pole teeth 50 of the two yokes 10a, 20a (10b, 20b) of each claw-pole assembly 30a (30b) are intermeshed with each other. Along the circumferential direction of the yokes 10a, 10b, 20a, 20b, the teeth 50 of the outer and inner yokes 10a, 20a (10b, 20b) of the claw-pole assembly 30a (30b) are arranged alternatively, and are misaligned from each other by an electrical angle of 180°. The teeth 50 of the yokes 10a, 20a (10b, 20b) of the claw-pole assembly 30a (30b) cooperatively form a cylinder-shaped sidewall 60. The outer and inner yokes 10a, 20a (10b, 20b) are located at two opposite ends of the sidewall 60. The circular holes 100 of the yokes 10a, 20a (10b, 20b) cooperatively define a through hole for receiving the rotor therein. Coils (not shown) wind around each sidewall 60 to generate an alternating magnetic field when a current is applied to the coils. The alternating magnetic field of the stator interacts with the magnetic field of a permanent magnet of the rotor to drive the motor into rotation. A narrow gap 62 is defined between each two neighboring pole teeth 50 of the sidewalls 60 for the relatively larger size of the slots 80 than the teeth 50. The gaps 62 between the teeth 50 are filled with resin inserted by insert molding, and thus fixedly combining the inner and outer yokes 10a, 10b (20a, 20b) together to form the claw-pole assembly 30a (30b).

The two claw-pole assemblies 30a, 30b are then arranged back-to-back. The four yokes are arranged in sequence: the outer yoke 10a, the inner yoke 20a of the upper claw-pole assembly 30a, the inner yoke 20b, and the outer yoke 10b of the lower claw-pole assembly 30b. The inner yokes 20a, 20b of the two claw-pole assemblies 30a, 30b abut each other and are located approximately in a middle of the stator. The outer yokes 10a, 10b of the two claw-pole assemblies 30a, 30b are spaced from each other. The outer yoke 10a of the upper claw-pole assembly 30a is located at a top end of the stator, whilst the outer yoke 10b of the lower claw-pole assembly 30b is located at a bottom end of the stator. The two claw-pole assemblies 30a, 30b are misaligned from each other by an electrical angle of 90°. The pins 70 of the two inner yokes 20a, 20b are alternatively arranged; one pin of each inner yoke 20a, 20b is located between the two pins 70 of the other inner yoke 20b, 20a. The four pins 70 are parallel to each other. The coils wound on each sidewall 60 of the claw-pole assembly 30a, 30b have two ends (not shown) connected to the two pins 70 of a corresponding inner yoke 20a, 20b. Thus the coils are electrically connected to a power source (not shown) by the pins 70. During operation of the motor, a current is applied to the coils to establish alternating magnetic filed, interacting with the magnetic field of the rotor to drive the rotor into rotation. As the pins 70 are integrally formed with the inner yokes 20a, 20b of the stator, production and assembly of the motor is simplified. Also the location of the pins 70 is more accurate and thus prevents separation from the stator; the coils thus can be connected to the pins 70 correctly, and thus avoid in-operation of the motor.

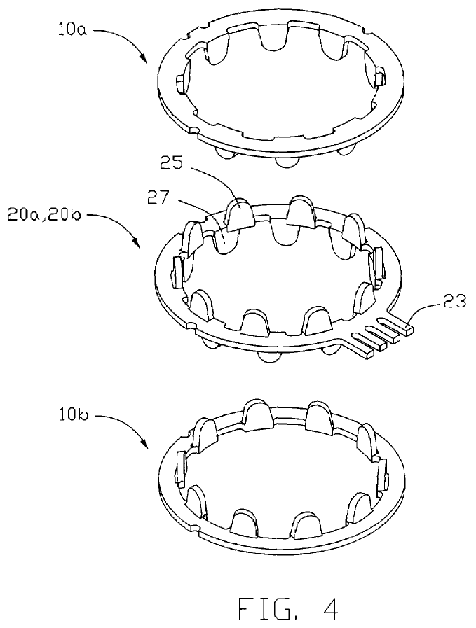

FIG. 4 illustrates the motor stator in accordance with an alternative embodiment. Similar to the first embodiment, the motor stator also includes two claw-pole assemblies stacked together. Each claw-pole assembly includes an inner yoke 20a, 20b and an outer yoke 10a, 10b facing each other. A plurality of pole teeth 25, 27 extends perpendicularly from the inner circumference of the inner yokes 20a, 20b and cooperatively forms the sidewalls. The difference between the second embodiment and the first embodiment is that the two inner yokes 20a, 20b of the two claw-pole assemblies 30a, 30b are integrally formed. This inner yoke 20a, 20b includes a plurality of upper teeth 25 extending upwardly therefrom, and a plurality of lower teeth 27 extending downwardly therefrom. Part of each lower tooth 27 overlaps a corresponding upper tooth 25 along the circumferential direction of the inner yoke 20a, 20b. Four pins 70 are integrally formed and extend outwardly from the inner yoke 20a, 20b. The four pins 70 are parallel to each other and are evenly spaced from each other. The four pins 70 are coplanar, thus reducing the space occupied the pins 70. It can be understood that the pins 70 of the first embodiment can also be coplanar. For example, the two pins 70 of the inner yoke 20a of the upper claw-pole assembly 30a bend downwardly and then transversely, thus forming coplanar-type pins. Alternatively, the two pins 70 of the inner yoke 20b of the lower claw-pole assembly 30b can bend upwardly and then transversely. Also all the pins 70 of the two inner yokes 20a, 20b of the two claw-pole assemblies 30a, 30b may bend towards each other and then extend transversely to form coplanar-typed pins 70.

While the invention has been described in connection with what is presently considered to be the most practical and preferred embodiments, it is to be understood that the invention is not limited to the disclosed embodiments, but, on the contrary, is intended to accommodate various modifications and equivalent arrangements. The stator in accordance with the preferred embodiments of the present invention comprises two claw-pole assemblies 30a, 30b arranged back-to-back. The number of the claw-pole assemblies 30a, 30b can be changed according to the precision requirements of the motor, it can be only one, and it can also can be three or more. The number of the teeth 50 of each yoke 10a, 10b, 20a, 20b is also decided by the precision requirement of the motor, being not limited to the disclosed embodiments.

What is claimed is:

1. A motor stator comprising at least one claw-pole assembly for coils wound thereon, the at least one claw-pole assembly comprising a pair of yokes facing towards each other, each of the yokes being ring-shaped, a plurality of pole teeth extending from each of the yokes, the pole teeth of each yoke being spaced from each other and defining a plurality of slots therebetween, the pole teeth of the two yokes being intermeshed with each other and being arranged in alternating fashion along a circumferential direction of the yokes, the teeth of the two yokes cooperatively forming a cylinder-shaped sidewall for receiving a rotor therein and the coils wound therearound, several pins extending from and integrally formed with at least one of the yokes as a monolithic piece for electrically connecting the coils to a power source.

2. The motor stator as claimed in claim 1, wherein the at least one claw-pole assembly comprises two claw-pole assemblies arranged back-to-back, one of the pair of yokes of each claw-pole assembly abutting that of the other claw-pole assembly, the pins being formed on the two abutting yokes.

3. The motor stator as claimed in claim 2, wherein the two abutting yokes are integrally formed as a monolithic piece.

4. The motor stator as claimed in claim 2, wherein the two abutting yokes are separately formed, and each of the abutting yokes forms two pins thereon.

5. The motor stator as claimed in claim 4, wherein the pins are parallel to and spaced from each other.

6. The motor stator as claimed in claim 5, wherein the pins are coplanar, the pins of one of the two abutting yokes bending towards the pins of the other two abutting yokes.

7. The motor stator as claimed in claim 5, wherein the pins of the two abutting yokes bend towards each other.

8. The motor stator as claimed in claim 1, wherein each yoke forms one pin thereon.

9. The motor stator as claimed in claim 1, wherein the pins are formed on only one of the pair of yokes.

10. The motor stator as claimed in claim 1, wherein the pins are coplanar and parallel to each other.

11. The motor stator as claimed in claim 1, wherein the pins are extend from an outer circumference of the at least one of the yokes, and the pole teeth of each yoke extend perpendicularly from an inner circumference thereof.

12. A motor stator comprising:
an upper outer yoke;
a lower outer yoke; and
at least one inner yoke sandwiched between the outer yokes;
wherein each of the outer yokes includes a plurality of first teeth and the at least one inner yoke includes a plurality of second teeth, the first and second teeth being extended toward and intermeshed with each other so that two neighboring first and second teeth are misaligned from each other with an electrical angle of 180°, and wherein the at least one inner yoke is integrally formed with a plurality of pins as a monolithic piece, the pins being adapted for connecting with a power source.

13. The motor stator as claimed in claim 12, wherein the pins are horizontally, outwardly extended from the at least one inner yoke, while the first and second teeth are vertically extended.

14. The motor stator as claimed in claim 12, wherein the at least one inner yoke includes an upper inner yoke and a lower inner yoke, some of the pins being integrally formed with the upper inner yoke as a monolithic piece, and the others of the pins being integrally formed with the lower inner yoke as a monolithic piece.

15. The motor stator as claimed in claim 14, wherein the pins are horizontally, outwardly extended from the upper and lower inner yokes, while the first and second teeth are vertically extended in which the second teeth of the upper inner yoke are extended upwardly and the second teeth of the lower inner yoke are extended downwardly.
